(19) United States
(12) Patent Application Publication
(10) Pub. No.: US 2015/0036510 A1
(43) Pub. Date: Feb. 5, 2015

(54) METHOD AND DEVICE FOR MEASURING ETHERNET PERFORMANCE

(71) Applicant: Huawei Technologies Co., Ltd., Shenzhen (CN)

(72) Inventors: Pengcheng BAO, Shenzhen (CN); Donghong PENG, Shenzhen (CN); Hongming LIU, Shenzhen (CN)

(21) Appl. No.: 14/519,786

(22) Filed: Oct. 21, 2014

Related U.S. Application Data
(63) Continuation of application No. PCT/CN2012/083466, filed on Oct. 25, 2012.

(30) Foreign Application Priority Data
May 9, 2012 (CN) 201210141998.8

(51) Int. Cl. H04L 12/26

(52) U.S. Cl. CPC H04L 43/08; H04L 12/4641
USPC 370/241.1

(57) ABSTRACT

A method and device for measuring Ethernet performance, in which, a first OAM protocol frame transmitted by a local end network device to a peer end network device carries a measurement object indicator, so that the peer end network device can obtain peer end measurement statistical information corresponding to the measurement object indicator according to a corresponding relationship between the measurement object indicator and the peer end measurement statistical information. Since different measurement object indicators may correspond to different peer end measurement statistical information, the flow-based measurement can be achieved and, thus, the problem that measurements in the P2MP topology network cannot be implemented in the prior art is solved, thereby improving the capability of measuring network performance.

### CROSS-REFERENCE TO RELATED APPLICATIONS

This application is a continuation of International Patent Application No. PCT/CN2012/083466, filed on Oct. 25, 2012, which claims priority to Chinese patent application No. 201210141998.8, filed on May 9, 2012, both of which are hereby incorporated by reference in their entireties.

### TECHNICAL FIELD

The present application relates to measurement technologies and, in particular, to a method and a device for measuring Ethernet performance.

### BACKGROUND

An operation administration and maintenance (OAM) model defined in an Ethernet includes maintenance entity group (MEG) end point (MEP). MEP is the end point of MEG and is able to initiate and terminate an OAM protocol frame which is used for measuring Ethernet performance. The network performance measurement may include the measurement of network performance such as the frame loss rate, frame delay, frame jitter and throughput. Take a single-ended measurement of frame loss rate as an example, a local end network device transmits a loss measurement message (LMM) frame to a peer end network device, where the LMM frame contains a transmitted service packet statistic value of the local end network device at the time when the local end network device transmits this LMM frame, and the peer end network device returns a loss measurement reply (LMR) frame, where the LMR frame contains a received service message statistic value of the peer end network device at the time when the peer end network device receives this LMM frame. Then, the local end network device may measure the frame loss rate according to the statistic value of service messages contained in the received LMR frame.

However, in a point to multi-point (P2MP) topology network, in other words, there is P2MP network connection between the local end network device and the peer end network device, the above measurement method is not available.

### SUMMARY

Embodiments of the present application provide a method and a device for measuring Ethernet performance, so as to solve the problem of measuring P2MP topology network performance, thereby improving the capability of measuring network performance.

One aspect, a method for measuring Ethernet performance, includes:

obtaining, by a local end network device, a measurement object indicator according to a target flow to be measured, wherein the measurement object indicator is corresponding to the target flow;

transmitting, by the local end network device, a first OAM protocol frame, to a peer end network device, where the first OAM protocol frame contains the measurement object indicator, so that the peer end network device obtains peer end measurement statistical information corresponding to the measurement object indicator, according to a corresponding relationship between the measurement object indicator and the peer end measurement statistical information;

receiving, by the local end network device, a second OAM protocol frame, transmitted by the peer end network device, where the second OAM protocol frame contains the measurement object indicator and the peer end measurement statistical information; and

measuring, by the local end network device, Ethernet performance of the target flow, according to the measurement object indicator and the peer end measurement statistical information.

Another aspect, a method for measuring Ethernet performance, includes:

receiving, by a peer end network device, a first OAM protocol frame transmitted by a local end network device, where the first OAM protocol frame contains a measurement object indicator, and the measurement object indicator is obtained by the local end network device according to a target flow to be measured;

obtaining, by the peer end network device, peer end measurement statistical information corresponding to the measurement object indicator, according to a corresponding relationship between the measurement object indicator and the peer end measurement statistical information; and

transmitting, by the peer end network device, a second OAM protocol frame, to the local end network device, where the second OAM protocol frame contains the measurement object indicator and the peer end measurement statistical information, so that the local end network device measures Ethernet performance of the target flow according to the measurement object indicator and the peer end measurement statistical information.

Another aspect, an device for measuring Ethernet performance, includes:

an obtaining unit, configured to obtain a measurement object indicator according to a target flow to be measured, where the measurement object indicator is corresponding to the target flow;

a transmitter, configured to transmit a first OAM protocol frame to a peer end network device, where the first OAM protocol frame contains the measurement object indicator, so that the peer end network device obtains peer end measurement statistical information corresponding to the measurement object indicator, according to a corresponding relationship between the measurement object indicator and the peer end measurement statistical information;

a receiver, configured to receive a second OAM protocol frame transmitted by the peer end network device, where the second OAM protocol frame contains the measurement object indicator and the peer end measurement statistical information; and

a detector, configured to measure Ethernet performance of the target flow, according to the measurement object indicator and the peer end measurement statistical information.

Another aspect, an device for measuring Ethernet performance, includes:

a receiver, configured to receive a first OAM protocol frame transmitted by a local end network device, where the first OAM protocol frame contains a measurement object indicator, and the measurement object indicator is obtained by the local end network device according to a target flow to be measured;

an obtaining unit, configured to obtain peer end measurement statistical information corresponding to the measurement object indicator, according to a corresponding relationship between the measurement object indicator and the peer end measurement statistical information; and

a transmitter, configured to transmit a second OAM protocol frame to the local end network device, where the second OAM protocol frame contains the measurement object indicator and the peer end measurement statistical information, so that the local end network device measures Ethernet performance of the target flow according to the measurement object indicator and the peer end measurement statistical information.

In the methods and devices, a first OAM protocol frame transmitted by a local end network device to a peer end network device carries a measurement object indicator, so that the peer end network device can obtain peer end measurement statistical information corresponding to the measurement object indicator according to a corresponding relationship between the measurement object indicator and the peer end measurement statistical information. Since different measurement object indicators may correspond to different peer end measurement statistical information, the flow-based measurement can be achieved and, thus, the problem that measurements in the P2MP topology network cannot be implemented in the prior art is solved, thereby improving the capability of measuring network performance.

### BRIEF DESCRIPTION OF DRAWINGS

To describe the technical solutions in embodiments of the present application or in the prior art more clearly, the following briefly introduces the accompanying drawings needed for describing the embodiments or the prior art. Apparently, the accompanying drawings in the following description illustrate merely some embodiments of the present application, and persons of ordinary skill in the art can derive other drawings from these accompanying drawings without creative effort.

FIG. 1 is a schematic flowchart of a method for measuring Ethernet performance according to an embodiment of the present application;

FIG. 2 is a schematic diagram of an LMM frame in the embodiment corresponding to FIG. 1;

FIG. 3 is a schematic diagram of an LMR frame in the embodiment corresponding to FIG. 1;

FIG. 4 is a schematic diagram of a flow identifier TLV in an LMM frame;

FIG. 5 is a schematic flowchart of a method for measuring Ethernet performance according to another embodiment of the present application;

FIG. 6 is a schematic diagram of a device for measuring Ethernet performance according to another embodiment of the present application; and

FIG. 7 is a schematic diagram of a device for measuring Ethernet performance according to another embodiment of the present application.

### DESCRIPTION OF EMBODIMENTS

To make the objectives, technical solutions, and advantages of embodiments of the present application more clearly, the following describes the technical solutions in embodiments of the present application with reference to the accompanying drawings in embodiments of the present application. Apparently, the described embodiments are merely a part rather than all embodiments of the present application. All other embodiments obtained by persons of ordinary skill in the art based on embodiments of the present application without creative effort shall fall within the protection scope of the present application.

The technical solutions of the present application may be applied in any measurement of Ethernet performance, for example: the measurement of frame loss rate, frame delay, frame jitter or throughput and the like.

The local end network device or the peer end network device described in the present application may be an optical network terminal (ONT), a customer premises equipment (CPE), a digital subscriber line access multiplexer (DSLAM), a router or a switch. The local end network device or the peer end network device described in the present application may also be other network devices.

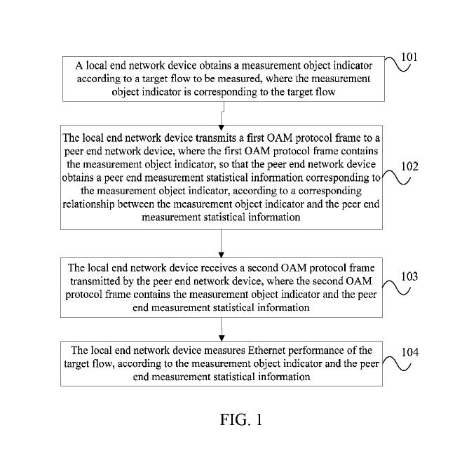

FIG. 1 is a schematic flowchart of a method for measuring Ethernet performance according to an embodiment of the present application. As shown in FIG. 1, the method includes:

101: A local end network device obtains a measurement object indicator according to a target flow to be measured, where the measurement object indicator is corresponding to the target flow.

Optionally, in an optional implementation of the embodiment, the target flow may be defined by using a four-tuple composed of fields in Ethernet service packet header, where the four-tuple is <destination address (DA), source address (SA), service priority and virtual local area network (VLAN) identifier>; or, the target flow to be measured may be defined by using a subset of the above four-tuple, which will not be limited in this embodiment. For example, if multiple services of a certain user use different VLANs, then a target flow of a certain service of the user may be defined by selecting a two-tuple which is <SA, VLAN ID>, where the VLAN ID refers to the VLAN identifier.

It could be understood that, before performing the measurement, the local end network device may recognize the target flow to be measured according to an access control list (ACL) determined by a selected tuple. The ACL is an instruction list of interfaces of a router or a switch, and is used for controlling data packets which flow in or out of the interfaces. In general, the ACL includes a control list and a specified action. The ACL compares the rules in the control list with the data packets, and performs certain actions for a data packet which is in conformity with the control list, for example, the actions are allowing to pass, forbidding to pass, packet mirroring, traffic statistic and the like.

Optionally, in an optional implementation of the embodiment, in 101, the local end network device may specifically obtain the measurement object indicator corresponding to the target flow according to feature information of the target flow to be measured. The feature information may include one or multiple of a DA, an SA, a service priority or a VLAN ID.

102: The local end network device transmits a first OAM protocol frame to a peer end network device, where the first OAM protocol frame contains the measurement object indicator, so that the peer end network device obtains a peer end measurement statistical information corresponding to the measurement object indicator, according to a corresponding relationship between the measurement object indicator and the peer end measurement statistical information.

103: The local end network device receives a second OAM protocol frame transmitted by the peer end network device, where the second OAM protocol frame contains the measurement object indicator and the peer end measurement statistical information.

104: The local end network device measures Ethernet performance of the target flow, according to the measurement object indicator and the peer end measurement statistical information.

Optionally, in an optional implementation of the embodiment, after 101, the local end network device may also obtain local end measurement statistical information of the target flow; correspondingly, in 102, the first OAM protocol frame, transmitted from the local end network device to the peer end network device, may further contain the local end measurement statistical information. Then, in 103, the second OAM protocol frame received by the local end network device may further contain the local end measurement statistical information. In this case, in 104, the local end network device may specifically measure the Ethernet performance of the target flow according to the measurement object indicator, the local end measurement statistical information and the peer end measurement statistical information.

It should be understood that: the first OAM protocol frame, transmitted from the local end network device to the peer end network device, may further contain other fields in the prior art, which will not be repeated herein.

Optionally, in an optional implementation of the embodiment, in 101, the measurement object indicator obtained by the local end network device may include but is not limited to the fields in the frame header of the first OAM protocol frame or the fields in the frame payload of the first OAM protocol frame.

Specifically, the MEP configuration in the prior art may be adopted, namely, the peer end network device contains an MEP, where the MEP may be an extension of the MEP in the prior art, and the number of the object (i.e., the target flow) that each MEP can monitor is extended from one to multiple. Each target flow is configured with a group of measurement resource (which may include but is not limited to a flow ID (flow ID), a counter and a state machine). The MEP monitors each target flow, that is, the MEP matches the service packet through recognizing an ACL of the target flow, makes statistics of the matched service packets by utilizing the configured measurement resource, and generates the peer end measurement statistical information, therefore, the MEP realizes the flow-based monitoring.

Then, optionally, the first OAM protocol frame may use a field contained in the frame payload (i.e., a new field) as the measurement object indicator for indicating the target flow. For example, the field contained in the frame payload of the first OAM protocol frame may be the flow ID corresponding to the target flow. Correspondingly, after 102, and after the peer end network device receives the first OAM protocol frame, the OAM control layer entity contained in the peer end network device transmits the first OAM protocol frame to an MEP contained in the peer end network device, and then the MEP contained in the peer end network device may obtain the peer end measurement statistical information corresponding to the flow ID, according to the corresponding relationship between the flow ID and the peer end measurement statistical information.

Further, the flow ID in the embodiment of the present application, may be in the form of a type length value (TLV), namely, the flow ID includes: the type of the flow ID, the length of the flow ID and the value of the flow ID.

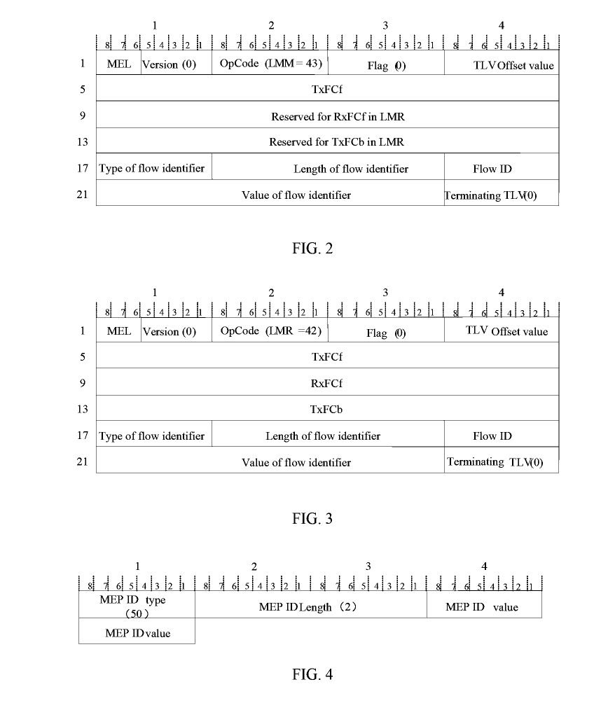

Take a single-ended measurement of frame loss rate as an example, the local end network device may transmit an LMM frame to the peer end network device, where the LMM frame carries flow ID. In this embodiment, the flow ID may specifically be represented in the form of TLV. Regarding the diagram of the LMM frame, please refer to FIG. 2. Each field in FIG. 2 has the following meaning:

MEL: this field refers to the MEG level, and is used for identifying the MEG level of the LMM frame. The value range is from 0 to 7.

Version: this field is used for identifying the version of the OAM protocol. In the prior art (for example, International Telecommunication Union (ITU)-Y.1731 protocol), the version is always 0.

Operation code (OpCode): this field is used for identifying the type of the LMM frame, and is used for recognizing the content of other parts of the LMM frame. Where, the OpCode of the LMM frame is 43, and the OpCode of the LMR frame is 42.

Tag: the utilization of each bit in this field depends on the type of the LMM frame.

TLV offset value: this field contains the offset quantity of the first TLV relative to the TLV offset value field. The value of this field is relative to the type of LMM frame. When the TLV offset value is 0, it points to the first byte after the TLV offset value field.

TxFcf: this field is used for recording a transmitted service packet statistic value at the time when the LMM frame is transmitted.

Reserved for RxFCf in LMR: this field is used for recording in the LMR frame, by the peer end network device, a received service message statistic value at the time when the LMM frame is received.

Reserved for TxFCb in LMR: this field is used for recording in the LMR frame, by the peer end network device, a transmitted service packet statistic value at the time when the LMR frame is transmitted.

Terminating TLV: this field is used for filling, and this field may be a value that all bytes are zero.

Different from the LMM frame in the prior art, the LMM frame in this embodiment further contains a flow identifier (Flow ID TLV) (namely, a flow ID in the form of TLV), and the Flow ID TLV includes: type of the flow identifier (Flow type), length of the flow identifier (Length) and value of the flow identifier (Flow ID).

Each field is illustrated as following:

Flow type: 1 byte, representing type of TLV value;

Length: 2 bytes, representing length of a Flow ID;

Flow ID: 4 bytes, the number of bytes occupied by this field is indicated by “Length”, this field represents the flow ID which is allocated to MEP (specifically, a peer end network device) for making statistic.

Correspondingly, the peer end network device may transmit an LMR frame to the local end network device, where the LMR frame carries the flow ID. In this embodiment, the flow ID may specifically be represented in the form of TLV, please refer to FIG. 3 for the structure of the LMR frame. Specifically, the peer end network device copies the value of TxFCf in the LMM frame into the TxFCf field in the LMR frame, a transmitted statistic value in a peer end measurement statistical information corresponding to the flow identifier is carried in the TxFCb field, and a received statistic value in the peer end measurement statistical information corresponding to the flow identifier is carried in the RxFCf field, where the transmitted statistic value is obtained according to the corresponding relationship between the flow identifier and the peer end measurement statistical information, and the received statistic value is obtained according to the corresponding relationship between the flow identifier and the peer end measurement statistical information.

Then, optionally, the first OAM protocol frame may use a field (i.e., an existing field) contained in the frame header as the measurement object indicator for indicating a target flow. For example, the fields contained in the frame header of the first OAM protocol frame may be one or multiple of DA, SA, service priority and VLAN ID. Taking a two-tuple which is <SA, service priority> as an example, correspondingly, after 102, and after the peer end network device receives the first OAM protocol frame, the OAM control layer entity contained in the peer end network device transmits the first OAM protocol frame to an MEP contained in the peer end network device, then the MEP contained in the peer end network device may obtain the peer end measurement statistical information corresponding to the two-tuple which is <SA, service priority>, according to the correspondingly relationship between the two-tuple which is <SA, service priority> and the peer end measurement statistical information.

Specifically, the MEP configuration in the prior art may be extended, that is, the peer end network device may contain two or more MEPs, so that every MEP can still monitor one object (i.e., target flow) according to the solutions in the prior art. Where, each MEP is configured with a group of measurement resource (which may include but not limited to an MEP identifier (MEP ID), a counter and a state machine), respectively, and monitors each target flow, that is, the MEPs match the service packet through recognizing an ACL of the target flow, makes statistics of the matched service packets by utilizing the measurement resource respectively allocated for each MEP, and generates the peer end measurement statistical information, therefore, the MEPs realize the flow-based monitoring.

Then, optionally, the first OAM protocol frame may use a field contained in the frame header (i.e., a new field) as the measurement object indicator for indicating the target flow. For example, the field contained in the frame header of the first OAM protocol frame may be the MEP ID corresponding to the target flow. Correspondingly, after 102, and after the peer end network device receives the first OAM protocol frame, the OAM control layer entity contained in the peer end network device transmits the first OAM protocol frame to an MEP corresponding to the MEP ID according to the MEP ID, where the MEP is one of multiple MEPs contained in the peer end network device, and then the MEP may obtain the peer end measurement statistical information corresponding to the MEP.

Take a single-ended measurement of frame loss rate as an example, the local end network device may transmit an LMM frame to the peer end network device, where the LMM frame carries MEP ID. In this embodiment, the MEP ID may specifically be represented in the form of TLV. Regarding the structure of the MEP ID TLV (i.e., MEP ID in TLV format) in this embodiment, please refer to FIG. 4. The MEP ID TLV includes: type of the MEP (MEP type), length of the MEP ID (Length) and value of the MEP ID (MEP ID). Each field is illustrated as following:

MEP type: 1 byte, representing type of TLV value; here, a reserved TLV type value 50 may be used for representing MEP ID TLV;

Length: 2 bytes, representing length of Flow ID;

MEP ID: 2 bytes, the number of bytes occupied by this field is indicated by “Length” indicator, this field represents the ID of the target MEP, and a format required by International Telecommunication Union (ITU)-Y.1731 protocol standard may be used as the format of the MEP ID.

Optionally, in an optional implementation mode of the embodiment, take the single-ended measurement of frame loss rate as an example, the local end network device, according to the measurement object indicator, the local end measurement statistical information and the peer end measurement statistical information contained in the received LMR frame, may specifically obtain TxFCf field, RxFCf field and TxFCb field from the LMR frame, and temporarily save them together with the current statistic value RxFCl of the local received counter of the local end network device. The above testing process is performed once again by using the LMM frame. Through two times of LMM/LMR testing process, the frame loss may be calculated by using the formula as following:

FrameLossRate_{remote-end}=|TxFCf[t_{c}]−TxFCf[tₚ]|−|RxFCf[t_{c}]−RxFCf[tₚ]|

FrameLossRate_{near-end}=|TxFCb[t_{c}]−TxFCb[tₚ]|−|RxFCl[t_{c}]−RxFCl[tₚ]|

Where, the near-end measurement is to measure the packet loss value of packets transmitted by the peer end and to the local end, i.e., the packet loss value associated with packets transmitted by the peer end network device and received by the local end network device. The peer end measurement is to measure the packet loss value associated with packets transmitted by the local end and received by the peer end, i.e., the packet loss value associated with packets transmitted by the local end network device and received by the peer end network device.

TxFCf[t_{c}] is a transmitted service packet statistic value of the local end network at the time when the local end network transmits this LMM frame,

RxFCf[t_{c}] is a received service packet statistic value of the peer end network at the time when the peer end network receives this LMM frame,

TxFCf[tₚ] is a transmitted service packet statistic value of the local end network at the time when the local end network transmits a previous LMM frame,

RxFCf[tₚ] is a received service packet statistic value of the peer end network at the time when the peer end network receives a previous LMM frame;

TxFCb[t_{c}] is a transmitted service packet statistic value of the peer end network at the time when the peer end network transmits this LMM frame,

RxFCl[t_{c}] is a received service packet statistic value of the local end network at the time when the local end network receives this LMM frame,

TxFCb[tₚ] is a transmitted service packet statistic value of the peer end network at the time when the peer end network transmits a previous LMM frame,

RxFCl[tₚ] is a received service packet statistic value of the local end network at the time when the local end network receives a previous LMM frame.

In this embodiment, a first OAM protocol frame transmitted by a local end network device to a peer end network device carries a measurement object indicator, so that the peer end network device can obtain peer end measurement statistical information corresponding to the measurement object indicator according to a corresponding relationship between the measurement object indicator and the peer end measurement statistical information. Since different measurement object indicators may correspond to different peer end measurement statistical information, the flow-based measurement can be achieved and, thus, the problem that measurements in the P2MP topology network cannot be implemented in the prior art is solved, thereby improving the capability of measuring network performance.

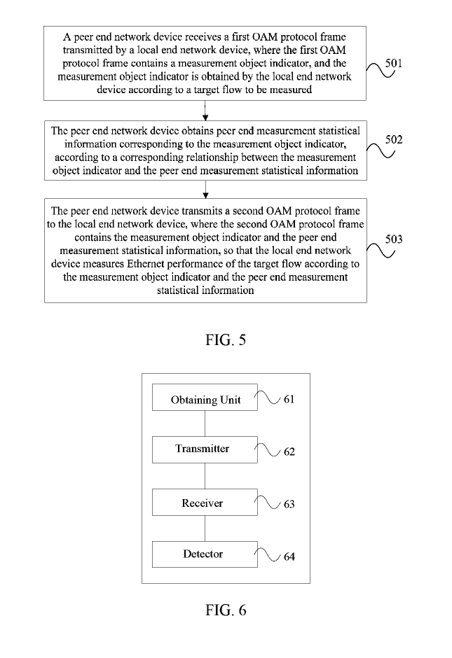

FIG. 5 is a schematic flowchart of a method for measuring Ethernet performance according to another embodiment of the present application, as shown in FIG. 5, the method includes:

501: A peer end network device receives a first OAM protocol frame transmitted by a local end network device, where the first OAM protocol frame contains a measurement object indicator, and the measurement object indicator is obtained by the local end network device according to a target flow to be measured.

Specifically, the target flow may be defined by using a four-tuple composed of fields in Ethernet service packet header, where the four-tuple is <destination address (DA), source address (SA), service priority and virtual local area network (VLAN) identifier>; or, the target flow to be measured may be defined by using a subset of the above four-tuple, which will not be limited in this embodiment. For example, if multiple services of a certain user use different VLANs, then a target flow of a certain service of the user may be defined by selecting a two-tuple which is <SA, VLAN ID>.

Before performing the measurement, the local end network device may recognize the target flow to be measured according to an access control list (ACL) determined by a selected tuple. The ACL is an instruction list of interfaces of a router or a switch, and is used for controlling data packets which flow in or out of the interfaces. In general, the ACL includes a control list and specified actions. The ACL compares the rules in the control list with the data packets, and performs certain actions for a data packet which is in conformity with the control list, for example, the actions are allowing to pass, forbidding to pass, packet mirroring, traffic statistic and the like.

Optionally, in an optional implementation of the embodiment, the local end network device may specifically obtain the measurement object indicator corresponding to the target flow according to feature information of the target flow to be measured. The feature information may include one or multiple of a DA, an SA, a service priority or a VLAN ID.

502: The peer end network device obtains peer end measurement statistical information corresponding to the measurement object indicator, according to a corresponding relationship between the measurement object indicator and the peer end measurement statistical information.

503: The peer end network device transmits a second OAM protocol frame to the local end network device, where the second OAM protocol frame contains the measurement object indicator and the peer end measurement statistical information, so that the local end network device measures Ethernet performance of the target flow according to the measurement object indicator and the peer end measurement statistical information.

Optionally, in an optional implementation of the embodiment, before 501, the local end network device may also obtain local end measurement statistical information of the target flow; correspondingly, in 501, the first OAM protocol frame, received by the peer end network device, may further contain the local end measurement statistical information. Then, in 503, the second OAM protocol frame, transmitted from the peer end network device to the local end network device may further contain the local end measurement statistical information. In this case, the local end network device may specifically measure the Ethernet performance of the target flow according to the measurement object indicator, the local end measurement statistical information and the peer end measurement statistical information.

It could be understood that: the first OAM protocol frame received by the peer end network device may further contain other fields in prior art, which will be not repeated herein.

Optionally, in an optional implementation of the embodiment, the measurement object indicator, contained in the first OAM protocol frame, may include but is not limited to the fields in the frame header of the first OAM protocol frame or the fields in the frame payload of the first OAM protocol frame.

Specifically, the MEP configuration in the prior art may be adopted, namely, the peer end network device contains an MEP, where the MEP may be an extension of the MEP in the prior art, and the number of the object (i.e., the target flow) that each MEP can monitor is extended from one to multiple. Each target flow is configured with a group of measurement resource (which may include but is not limited to a flow ID (ID), a counter and a state machine). The MEP monitors each target flow, that is, the MEP matches the service packet through recognizing an ACL of the target flow, makes statistics of the matched service packets by utilizing the configured measurement resource, and generates the peer end measurement statistical information, therefore, the MEP realizes the flow-based monitoring.

Then, optionally, the first OAM protocol frame may use a field contained in the frame payload (i.e., a new field) as the measurement object indicator for indicating the target flow. For example, the field contained in the frame payload of the first OAM protocol frame may be the flow ID corresponding to the target flow. Correspondingly, in 502, after the peer end network device receives the first OAM protocol frame, the OAM control layer entity contained in the peer end network device transmits the first OAM protocol frame to an MEP contained in the peer end network device, and then the MEP contained in the peer end network device may obtain the peer end measurement statistical information corresponding to the flow ID, according to the corresponding relationship between the flow ID and the peer end measurement statistical information. For a detailed description, please refer to the relative content in the embodiment corresponding to FIG. 1, which will not be repeated herein.

Then, optionally, the first OAM protocol frame may use a field (i.e., an existing field) contained in the frame header as the measurement object indicator for indicating a target flow. For example, the fields contained in the frame header of the first OAM protocol frame may be one or multiple of DA, SA, service priority and VLAN ID. Taking a two-tuple which is <SA, service priority> as an example, correspondingly, in 502, and after the peer end network device receives the first OAM protocol frame, the OAM control layer entity contained in the peer end network device transmits the first OAM protocol frame to an MEP contained in the peer end network device, then the MEP contained in the peer end network device may obtain the peer end measurement statistical information corresponding to the two-tuple which is <SA, service priority>, according to the correspondingly relationship between the two-tuple which is <SA, service priority> and the peer end measurement statistical information.

Specifically, the MEP configuration in the prior art (i.e., the peer end network device contains one MEP) may be extended, that is, the peer end network device may contain two or more MEPs, so that every MEP can still monitor one object (i.e., target flow) according to the solutions in the prior art. Where, each MEP is configured with a group of measurement resource (which may include but not limited to an MEP identifier (MEP ID), a counter and a state machine) respectively, and monitors each target flow, that is, the MEPs match the service packet through recognizing an ACL of the target flow, makes statistics of the matched service packets by utilizing the measurement resource respectively allocated for each MEP, and generates the peer end measurement statistical information, therefore, the MEPs realize the flow-based monitoring.

Then, optionally, the first OAM protocol frame may use a field contained in the frame header (i.e., a new field) as the measurement object indicator for indicating the target flow. For example, the field contained in the frame header of the first OAM protocol frame may be the MEP ID corresponding to the target flow. Correspondingly, in 502, and after the peer end network device receives the first OAM protocol frame, the OAM control layer entity contained in the peer end network device transmits the first OAM protocol frame to an MEP corresponding to the MEP ID according to the MEP ID, where the MEP is one of multiple MEPs contained in the peer end network device, and then the MEP may obtain the peer end measurement statistical information corresponding to the MEP. For a detailed description, please refer to the relative content in the embodiment corresponding to FIG. 1, which will not be repeated herein.

In this embodiment, a first OAM protocol frame transmitted by a local end network device to a peer end network device carries a measurement object indicator, so that the peer end network device can obtain peer end measurement statistical information corresponding to the measurement object indicator according to a corresponding relationship between the measurement object indicator and the peer end measurement statistical information. Since different measurement object indicators may correspond to different peer end measurement statistical information, the flow-based measurement can be achieved and, thus, the problem that measurements in the P2MP topology network cannot be implemented in the prior art is solved, thereby improving the capability of measuring network performance.

It should be noted that the aforementioned method embodiments are described as a combination of a series of actions for simplicity. However, persons skilled in the art should know that the present application is not limited by the described action sequence because some steps may be performed in any other sequence or performed simultaneously according to the present application. Furthermore, persons skilled in the art should also know that the embodiments described in the specification are preferred embodiments, and the related actions and modules may not be necessary for the present application.

In the above embodiments, each embodiment has its emphasis. For contents not described in detail in one embodiment, please refer to related contents described in other embodiments.

FIG. 6 is a schematic diagram of a device for measuring Ethernet performance according to another embodiment of the present application, as shown in FIG. 6, the device for measuring Ethernet performance according to this embodiment may include an obtaining unit 61, a transmitter 62, a receiver 63 and a detector 64. Where, the obtaining unit 61 is configured to obtain a measurement object indicator according to a target flow to be measured, where the measurement object indicator is corresponding to the target flow; the transmitter 62 is configured to transmit a first OAM protocol frame to a peer end network device, where the first OAM protocol frame contains the measurement object indicator, so that the peer end network device obtains a peer end measurement statistical information corresponding to the measurement object indicator, according to a corresponding relationship between the measurement object indicator and the peer end measurement statistical information; the receiver 63 is configured to receive a second OAM protocol frame transmitted by the peer end network device, where the second OAM protocol frame contains the measurement object indicator and the peer end measurement statistical information; and the detector 64 is configured to measure Ethernet performance of the target flow, according to the measurement object indicator and the peer end measurement statistical information.

Optionally, in an optional implementation of the embodiment, the target flow may be defined by using a four-tuple composed of fields in Ethernet service packet header, where the four-tuple is <destination address (DA), source address (SA), service priority and virtual local area network (VLAN) identifier>; or, the target flow to be measured may be defined by using a subset of the above four-tuple, which will not be limited in this embodiment. For example, if multiple services of a certain user use different VLANs, then a target flow of a certain service of the user may be defined by selecting a two-tuple which is <SA, VLAN ID>.

Before performing the measurement, the device for measuring Ethernet performance may recognize the target flow to be measured according to an access control list (ACL) determined by a selected tuple. The ACL is an instruction list of interfaces of a router or a switch, and is used for controlling data packets which flow in or out of the interfaces. In general, the ACL includes a control list and specified actions. The ACL compares the rules in the control list with the data packets, and performs certain actions for a data packet which is in conformity with the control list, for example, the actions are allowing to pass, forbidding to pass, packet mirroring, traffic statistic and the like.

Optionally, in an optional implementation of the embodiment, the obtaining unit 61 may specifically obtain the measurement object indicator corresponding to the target flow according to feature information of the target flow to be measured. The feature information may include at least one of a DA, an SA, a service priority or a VLAN ID.

Optionally, in an optional implementation of the embodiment, the obtaining unit 61 may further obtain local end measurement statistical information of the target flow; correspondingly, the first OAM protocol frame, transmitted from the transmitter 62 to the peer end network device, may further contain the local end measurement statistical information. Then, the second OAM protocol frame received by the receiver 63 may further contain the local end measurement statistical information. In this case, the detector 64 may specifically measure the Ethernet performance of the target flow, according to the measurement object indicator, the local end measurement statistical information and the peer end measurement statistical information.

It could be understood that: the first OAM protocol frame, transmitted from the transmitter 62 to the peer end network device, may further include other fields in the prior art, which will not be repeated herein.

Optionally, in an optional implementation of the embodiment, the measurement object indicator obtained by the obtaining unit 61 may include but is not limited to the fields in the frame header of the first OAM protocol frame or the fields in the frame payload of the first OAM protocol frame.

In this embodiment, a first OAM protocol frame transmitted by a transmitter to a peer end network device carries a measurement object indicator, so that the peer end network device can obtain peer end measurement statistical information corresponding to the measurement object indicator according to a corresponding relationship between the measurement object indicator and the peer end measurement statistical information. Since different measurement object indicators may correspond to different peer end measurement statistical information, the flow-based measurement can be achieved and, thus, the problem that measurements in the P2MP topology network cannot be implemented in the prior art is solved, thereby improving the capability of measuring network performance.

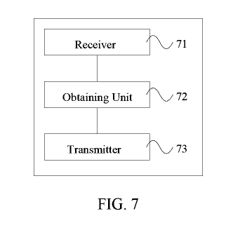

FIG. 7 is a schematic diagram of a device for measuring Ethernet performance according to another embodiment of the present application, as shown in FIG. 7, the device for measuring Ethernet performance of this embodiment may include a receiver 71, an obtaining unit 72 and a transmitter 73. Where, the receiver 71 is configured to receive a first OAM protocol frame transmitted by a local end network device, where the first OAM protocol frame contains a measurement object indicator, and the measurement object indicator is obtained by the local end network device according to a target flow to be measured; the obtaining unit 72 is configured to obtain peer end measurement statistical information corresponding to the measurement object indicator, according to a corresponding relationship between the measurement object indicator and the peer end measurement statistical information; and the transmitter 73 is configured to transmit a second OAM protocol frame to the local end network device, where the second OAM protocol frame contains the measurement object indicator and the peer end measurement statistical information, so that the local end network device measures Ethernet performance of the target flow according to the measurement object indicator and the peer end measurement statistical information.

Optionally, in an optional implementation of the embodiment, the target flow may be defined by using a four-tuple composed of fields in Ethernet service packet header, where the four-tuple is <destination address (DA), source address (SA), service priority and virtual local area network (VLAN) identifier>; or, the target flow to be measured may be defined by using a subset of the above four-tuple, which will not be limited in this embodiment. For example, if multiple services of a certain user use different VLANs, then a target flow of a certain service of the user may be defined by selecting a two-tuple which is <SA, VLAN ID>.

Before performing the measurement, the local end network device may recognize the target flow to be measured according to an access control list (ACL) determined by a selected tuple. The ACL is an instruction list of interfaces of a router or a switch, and is used for controlling data packets which flow in or out of the interfaces. In general, the ACL includes a control list and specified actions. The ACL compares the rules in the control list with the data packets, and performs certain actions for a data packet which is in conformity with the control list, for example, the actions are allowing to pass, forbidding to pass, packet mirroring, traffic statistic and the like.

Optionally, in an optional implementation of the embodiment, the local end network device may specifically obtain the measurement object indicator corresponding to the target flow according to feature information of the target flow to be measured. The feature information may include at least one of a DA, an SA, a service priority or a VLAN ID.

Optionally, in an optional implementation of the embodiment, the measurement object indicator, contained in the first OAM protocol frame received by the receiver 71, may include but is not limited to the fields in the frame header of the first OAM protocol frame or the fields in the frame payload of the first OAM protocol frame.

Specifically, the MEP configuration in the prior art may be adopted, namely, the obtaining unit 72 contains an MEP, where the MEP may be an extension of the MEP in the prior art, and the number of the object (i.e., the target flow) that each MEP can monitor is extended from one to multiple. Each target flow is configured with a group of measurement resource (which may include but is not limited to a flow ID (ID), a counter and a state machine). The obtaining unit 72 is also configured to monitor each target flow. That is, the MEP matches the service packet through recognizing an ACL of the target flow, makes statistics of the matched service packets by utilizing the configured measurement resource, and generates the peer end measurement statistical information, therefore, the MEP realizes the flow-based monitoring.

Then, optionally, the first OAM protocol frame may use a field contained in the frame payload (i.e., a new field) as the measurement object indicator for indicating the target flow. For example, the field contained in the frame payload of the first OAM protocol frame may be the flow identifier corresponding to the target flow; correspondingly, after the receiver 71 receives the first OAM protocol frame, the receiver transmits the first OAM protocol frame to the OAM control layer entity contained in the obtaining unit 72, and the OAM control layer entity contained in the obtaining unit 72 transmits the first OAM protocol frame to an MEP contained in the peer end network device, and then the MEP contained in the obtaining unit 72 may obtain the peer end measurement statistical information corresponding to the flow ID, according to the corresponding relationship between the flow identifier and the peer end measurement statistical information. For a detailed description, please refer to the relative content in the embodiment corresponding to FIG. 1, which will not be repeated herein.

Then, optionally, the first OAM protocol frame may use a field (i.e., an existing field) contained in the frame header as the measurement object indicator for indicating a target flow. For example, the fields contained in the frame header of the first OAM protocol frame may be one or multiple of DA, SA, service priority and VLAN ID. Taking a two-tuple which is <SA, service priority> as an example, correspondingly, after the receiver 71 receives the first OAM protocol frame, the receiver 71 transmits the first OAM protocol frame to the OAM control layer entity contained in the obtaining unit 72, and the OAM control layer entity contained in the obtaining unit 72 transmits the first OAM protocol frame to an MEP contained in the obtaining unit 72, then the MEP contained in the obtaining unit 72 may obtain the peer end measurement statistical information corresponding to the two-tuple which is <SA, service priority>, according to the correspondingly relationship between the two-tuple which is <SA, service priority> and the peer end measurement statistical information.

Specifically, the MEP configuration in the prior art may be extended, that is, the obtaining unit 72 may contain two or more MEPs, so that every MEP can still monitor one object (i.e., target flow) according to the solutions in the prior art. Where, each MEP is configured with a group of measurement resource (which may include but not limited to an MEP identifier (MEP ID), a counter and a state machine), respectively. The obtaining unit 72 is further configured to monitor each target flow, that is, the MEPs match the service packet through recognizing an ACL of the target flow, makes statistics of the matched service packets by utilizing the measurement resource respectively allocated for each MEP, and generates the peer end measurement statistical information, therefore, the MEPs realize the flow-based monitoring.

Then, optionally, the first OAM protocol frame may use a field contained in the frame header (i.e., a new field) as the measurement object indicator for indicating the target flow. For example, the field contained in the frame header of the first OAM protocol frame may be the MEP ID corresponding to the target flow. Correspondingly, after the receiver 71 receives the first OAM protocol frame, the receiver 71 transmits the first OAM protocol frame to the OAM control layer entity contained in the obtaining unit 72, and the OAM control layer entity contained in the obtaining unit 72 transmits the first OAM protocol frame to an MEP corresponding to the MEP ID according to the MEP ID, where the MEP is one of multiple MEPs contained in the obtaining unit 72, and then the MEP may obtain the peer end measurement statistical information corresponding to the MEP. For a detailed description, please refer to the relative content in the embodiment corresponding to FIG. 1, which will not be repeated herein.

In this embodiment, a first OAM protocol frame transmitted by a local end network device to a peer end network device carries a measurement object indicator, so that the obtaining unit can obtain peer end measurement statistical information corresponding to the measurement object indicator according to a corresponding relationship between the measurement object indicator and the peer end measurement statistical information. Since different measurement object indicators may correspond to different peer end measurement statistical information, the flow-based measurement can be achieved and, thus, the problem that measurements in the P2MP topology network cannot be implemented in the prior art is solved, thereby improving the capability of measuring network performance.

Persons of ordinary skill in the art could understand that, for the purpose of convenient and brief description, for a detailed working process of the system, device and unit described foregoing, reference may be made to corresponding process described in the above method embodiments, which will not be repeated herein.

In the embodiments provided in the present application, it should be understood that, the disclosed system, device and method may be implemented in other modes. For example, the described device embodiments are merely exemplary. For example, the unit division is merely logical function division and may be other divisions in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate part may or may not be separated physically, and parts displayed as units may or may not be physical units, may be located in one position, or may be distributed on multiple network units. A part or all of the units may be selected according to an actual need to achieve the objectives of the solutions of the embodiments.

In addition, functional units in embodiments of the present application may be integrated into one processing unit, or each of the units may exist alone physically, or two or more units are integrated into one unit. The integrated unit may be implemented through hardware, or may also be implemented in a form of hardware plus a software functional module. For example, the detector, the transmitter, the receiver and the obtaining unit may be implemented via a general central processing unit (CPU), an application specific integrated circuit (ASIC), or a field programmable gate array (FPGA).

The integrated unit implemented in the form of software functional unit may be stored in a computer readable storage medium. The software functional unit is stored in a storage medium, and contains several instructions used to instruct computer equipment (for example, a personal computer, a server, or network equipment) to perform the steps of the methods according to the embodiments of the present application. The storage medium may be any medium that can store program codes, such as a U disk, a removable hard disk, a read-only memory (ROM), a random access memory (RAM), a magnetic disk, or an optical disk.

Finally, it should be noted that the foregoing embodiments are merely intended for describing the technical solutions of the present application other than limiting the present application. Although the present application is described in detail with reference to the foregoing embodiments, persons of ordinary skill in the art should understand that they may still make modifications to the technical solutions described in the foregoing embodiments or make equivalent substitutions to some technical features thereof, without departing from the spirit and scope of the technical solutions of embodiments of the present application.

1. A method for measuring Ethernet performance, comprising:
obtaining, by a local end network device, a measurement object indicator corresponding to a target flow to be measured;
transmitting, by the local end network device, a first operation administration and maintenance (OAM) protocol frame to a peer end network device, wherein the first OAM protocol frame includes the measurement object indicator;
receiving, by the local end network device, a second OAM protocol frame from the peer end network device, wherein the second OAM protocol frame includes the measurement object indicator and the peer end measurement statistical information; and
measuring, by the local end network device, Ethernet performance of the target flow based on the measurement object indicator and the peer end measurement statistical information.

2. The method according to claim 1, further comprising, after obtaining the measurement object indicator:
obtaining, by the local end network device, local end measurement statistical information of the target flow;
wherein the first OAM protocol frame further includes the local end measurement statistical information;
wherein the second OAM protocol frame further includes the local end measurement statistical information; and
wherein measuring the Ethernet performance
of the target flow, is further based on the local end measurement statistical information.

3. The method according to claim 1, wherein the peer end network device comprises a maintenance entity group (MEG) end point (MEP) for obtaining the peer end measurement statistical information corresponding to the measurement object indicator; and
wherein the measurement object indicator comprises at least one of the group consisting of: a target address, a source address, a service priority and a virtual local area network identifier corresponding to the target flow.

4. The method according to claim 1, wherein the peer end network device comprises a maintenance entity group (MEG) end point (MEP) for obtaining the peer end measurement statistical information corresponding to the measurement object indicator; and
wherein the measurement object indicator is a flow identifier corresponding to the target flow.

5. The method according to claim 1, wherein the measurement object indicator is a maintenance entity group (MEG) end point (MEP) identifier corresponding to the target flow; and
wherein the peer end network device comprises at least two MEPs for obtaining the peer end measurement statistical information corresponding to the measurement object indicator and an OAM control entity for transmitting the first OAM protocol frame to one of the at least two MEPs based on the MEP identifier.

6. The method according to claim 1, wherein obtaining the measurement object indicator
is based on feature information of the target flow to be measured, wherein the feature information comprises at least one of the group consisting of: a target address, a source address, a service priority and a virtual local area network identifier.

7. A method for measuring Ethernet performance, comprising:
receiving, by a peer end network device, a first operation administration and maintenance (OAM) protocol frame from a local end network device, wherein the first OAM protocol frame includes a measurement object indicator corresponding to a target flow to be measured;
obtaining, by the peer end network device, peer end measurement statistical information corresponding to the measurement object indicator; and
transmitting, by the peer end network device, a second OAM protocol frame to the local end network device, wherein the second OAM protocol frame includes the measurement object indicator and the peer end measurement statistical information, so as to enable the local end network device to measure Ethernet performance of the target flow based on the measurement object indicator and the peer end measurement statistical information.

8. The method according to claim 7, wherein
the first OAM protocol frame further includes the local end measurement statistical information;
wherein the second OAM protocol frame further includes the local end measurement statistical information; and
wherein measurement of the Ethernet performance of the target flow by the local end network device is further based on
the local end measurement statistical information.

9. The method according to claim 7, wherein the peer end network device comprises a maintenance entity group (MEG) end point (MEP);
wherein the measurement object indicator comprises at least one of the group consisting of: a target address, a source address, a service priority and a virtual local area network identifier corresponding to the target flow; and
wherein the MEP obtains the peer end measurement statistical information corresponding to the measurement object indicator.

10. The method according to claim 7, wherein the peer end network device comprises a maintenance entity group (MEG) end point (MEP);
wherein the measurement object indicator is a flow identifier corresponding to the target flow; and
wherein the MEP obtains the peer end measurement statistical information corresponding to the measurement object indicator.

11. (canceled)

12. The method according to claim 7, wherein the peer end network device comprises at least two maintenance entity group (MEG) end points (MEPs) and an OAM control entity;
wherein the measurement object indicator is a MEP identifier corresponding to the target flow;
wherein the method further comprises: transmitting, by the OAM control entity, the first OAM protocol frame to one of the at least two MEPs based on the MEP and
wherein the one of the at least two MEPs corresponding to the MEP identifier obtains the peer end measurement statistical information corresponding to the measurement object indicator.

13. (canceled)

14. The method according to claim 7, wherein the
measurement object indicator is based on feature information of the target flow to be measured, wherein the feature information comprises at least one of the group consisting of: a target address, a source address, a service priority and a virtual local area network identifier.

15. A device for measuring Ethernet performance, comprising:
an obtaining unit, configured to obtain a measurement object indicator corresponding to the target flow;
a transmitter, configured to transmit a first operation administration and maintenance (OAM) protocol frame to a peer end network device, wherein the first OAM protocol frame includes the measurement object indicator, and wherein the measurement object indicator enables the peer end network device to obtain peer end measurement statistical information corresponding to the measurement object indicator;
a receiver, configured to receive a second OAM protocol frame from the peer end network device, wherein the second OAM protocol frame includes the measurement object indicator and the peer end measurement statistical information; and
a detector, configured to measure Ethernet performance of the target flow based on the measurement object indicator and the peer end measurement statistical information.

16. The device according to claim 15, wherein the obtaining unit is further configured to obtain local end measurement statistical information of the target flow;
wherein the first OAM protocol frame further includes the local end measurement statistical information;
wherein the second OAM protocol frame further includes the local end measurement statistical information; and
wherein measurement of the Ethernet performance of the target flow is further based on the local end measurement statistical information.

17. The device according to claim 15, wherein obtaining the measurement object indicator corresponding to the target flow is based on feature information of the target flow to be measured, wherein the feature information comprises at least one of the group consisting of: a target address, a source address, a service priority and a virtual local area network identifier.

18. A device for measuring Ethernet performance, comprising:
a receiver, configured to receive a first operation administration and maintenance (OAM) protocol frame from a local end network device, wherein the first OAM protocol frame includes a measurement object indicator corresponding to a target flow to be measured;
an obtaining unit, configured to obtain a peer end measurement statistical information corresponding to the measurement object indicator; and
a transmitter, configured to transmit a OAM protocol frame to the local end network device, wherein the second OAM protocol frame includes the measurement object indicator and the peer end measurement statistical information, so as to enable the local end network device to measure Ethernet performance of the target flow based on the measurement object indicator and the peer end measurement statistical information.

19. The device according to claim 18, wherein the obtaining unit comprises a maintenance entity group (MEG) end point (MEP), configured to obtain the peer end measurement statistical information corresponding to the measurement object indicator;
wherein the measurement object indicator comprises at least one of the group consisting of: a target address, a source address, a service priority and a virtual local area network identifier corresponding to the target flow.

20. The device according to claim 18, wherein the obtaining unit comprises contains a maintenance entity group (MEG) end point (MEP), configured to obtain the peer end measurement statistical information corresponding to the measurement object indicator;
wherein the measurement object indicator is a flow identifier corresponding to the target flow.

21. (canceled)

22. The device according to claim 18, wherein the measurement object indicator is a maintenance entity group (MEG) end point (MEP) identifier corresponding to the target flow;
wherein the obtaining unit comprises at least two MEPs and an OAM control entity;
wherein the OAM control entity is configured to transmit the first OAM protocol frame to one of the at least two MEPs based on the MEP identifier; and
wherein the one of the at least two MEPs corresponding to the MEP identifier is configured to obtain the peer end measurement statistical information corresponding to the maintenance entity group end point.

23. (canceled)
